(19) United States
(12) Patent Application Publication
(10) Pub. No.: US 2022/0019212 A1
(43) Pub. Date: Jan. 20, 2022

(54) SYSTEM AND METHOD FOR PROVIDING DIGITAL TWIN SERVICES FROM MULTIPLE DIGITAL TWIN PROVIDERS

(71) Applicant: ENDURICA, LLC, Findlay, OH (US)

(72) Inventor: William V. Mars, Findlay, OH (US)

(21) Appl. No.: 17/375,396

(22) Filed: Jul. 14, 2021

Related U.S. Application Data
(60) Provisional application No. 63/052,249, filed on Jul. 15, 2020.

(51) Int. Cl. G05B 23/02; G05B 17/02

(52) U.S. Cl. CPC G05B 23/0283; G05B 17/02

(57) ABSTRACT

A system for providing digital twin services for a physical asset from multiple twin providers can have a plurality of provider terminals, an asset owner terminal, and a server. The server can be in communication with the plurality of provider terminals and the asset owner terminal. The server can include a processor, a memory, an administration subsystem, and an operation subsystem. The memory can have a tangible, non-transitory computer readable medium with processor-executable instructions stored thereon. The administration subsystem and the operation subsystem can be configured to perform a variety of digital twin services, including instantiating a new digital twin from a provider, updating the digital twin using incrementation instructions from the twin provider and usage history recorded from a physical asset, and querying the digital twin to produce reports of current life remaining.

### CROSS-REFERENCE TO RELATED APPLICATIONS

This application claims the benefit of U.S. Provisional Application Ser. No. 63/052,249, filed on Jul. 15, 2020. The entire disclosure of the above application is incorporated herein by reference.

### FIELD

The present disclosure relates to a system and a method for providing digital twin services, and more particularly, to a system and a method that support multiple digital twin providers.

### INTRODUCTION

This section provides background information related to the present disclosure which is not necessarily prior art.

Various components of devices, machines, and structures, including various consumable components and components subject to wear and failure, can be designed with an expected lifetime or hours of service. Other components may be utilized until the component structurally fails in some way or becomes unusable for its intended purpose. Such components, including multicomponent structures or systems, can be referred to as physical assets. Knowing the remaining life of a physical asset can be important for not only the manufacturing industry, but also for general consumers. For example, knowing the remaining life of a physical asset of a vehicle can help an owner plan repairs and avoid potential hazards that could occur from an unexpected vehicle failure. Typically, physical assets can be maintained through reactive maintenance. Reactive maintenance relies heavily on visually inspecting the physical asset and the experience of the inspector. Undesirably, many physical assets do not facilitate practical visual inspections. For example, parts located in sealed enclosures or in hazardous locations cannot be safely inspected. In addition, many consumers may lack the experience to spot early signs of failures in physical assets. Manufacturers and suppliers can also provide an estimated remaining life for a stock physical asset to the consumer. However, these estimates generally do not factor in the specific operating loads and environmental exposures experienced by a particular physical asset owned by the consumer. Therefore, undesirably, these estimates may not accurately approximate the remaining life span of the physical asset according to specific operating loads and environmental exposures of the physical asset.

One known solution to these identified issues is to create a digital twin model of the stock physical asset, for example, as described in U.S. Pub. No. 2019/0102494 to Mars. A simulation can then be employed based on the operating history of the physical asset to approximate a remaining lifespan according to specific operating loads and environmental exposures, for example. However, undesirably, digital twins are often tailored to specific physical assets, materials of the physical asset, or types of loads being exerted on the physical asset, and therefore such systems cannot be broadly used across different industries. The developer of a digital twin, likewise, has conventionally been a single source or supplier, and such digital twins have typically involved specific end uses. In addition, these digital twins lack compatibility across different types of physical assets.

There is a continuing need for a system and method for providing digital twin services. Desirably, the system and method would support a broad range of physical assets, including physical assets of different manufacture and/or from different suppliers.

### SUMMARY

In concordance with the instant disclosure, a system and a method for providing digital twin services, which support a broad range of physical assets, have been surprisingly discovered.

It should be appreciated that the systems and methods of the present disclosure can be used for a wide variety of applications including, but not limited, to offshore platforms, earthquake bearings, building dampers, agriculture equipment, shipping and trucking industries, military, roads, and bridges.

In certain embodiments, systems for providing digital twin services for a physical asset from multiple twin providers can have a plurality of provider terminals, an asset owner terminal, and a server. The server can be in communication with the plurality of provider terminals and the asset owner terminal. The server can include a processor, a memory, an administration subsystem, and an operation subsystem. The memory can have a tangible, non-transitory computer readable medium with processor-executable instructions stored thereon. The administration subsystem can be configured to: receive a plurality of asset models with model implementation instructions from at least one of the provider terminals; store the plurality of asset models with the model implementation instructions into a model database; receive a digital twin request, from the asset owner terminal, for creating a digital twin instantiation of a selected asset model from the model database; create the digital twin instantiation for the physical asset; receive operating history data of the physical asset from a data source; store the operating history data of the physical asset; generate a reportable for the digital twin instantiation, the reportable based on the model implementation instructions; and transmit the reportable to the asset owner terminal. The operation subsystem can be configured to: receive a current life request from the administration subsystem and determine a current life of the digital twin instantiation using the operating history data and the model implementation instructions. The reportable can include the current life of the digital twin instantiation.

In certain embodiments, systems for providing digital twin services can include a plurality of provider terminals, an asset owner terminal, and a server. The server can be in communication with the plurality of provider terminals and the asset owner terminal. The server can include a processor, a memory, an administration subsystem, and an operation subsystem. The memory can have a tangible, non-transitory computer readable medium with processor-executable instructions stored thereon. The administration subsystem can be configured to: receive a plurality of asset models with model implementation instructions from at least one of the provider terminals; store the plurality of asset models with the model implementation instructions into a model database; receive a request, from the asset owner terminal, for creating a digital twin instantiation of a selected asset model from the model database; create the digital twin instantiation for the physical asset; receive operating history data of the physical asset from a data source; store the operating history data of the physical asset; generate a reportable for the digital twin instantiation, the reportable based on the model implementation instructions; and transmit the reportable to the asset owner terminal. The operation subsystem configured to: receive a current life request from the administration subsystem; determine a current life of the digital twin instantiation using the operating history data and the model implementation instructions; receive a residual life prediction request from the administration subsystem; and determine a residual life prediction by using the model implementation instructions, the current life, and a hypothetical operating history data. The residual life prediction being indicative of a residual life before reaching a predetermined state associated with the physical asset in operation. The reportable includes at least one of the current life and the residual life prediction.

In certain embodiments, methods for providing digital twin services for a physical asset from multiple digital twin providers can employ an embodiment of the aforementioned systems. The administration subsystem can receive a plurality of asset models with model implementation instructions from at least one of the provider terminals. The administration subsystem can store the plurality of asset models with the model implementation instructions into a model database. The administration subsystem can receive a digital twin request from the asset owner terminal for creating a digital twin instantiation of a selected asset model from the model database. The administration subsystem can create the digital twin instantiation for the physical asset. The administration subsystem can receive operating history data of the physical asset from a data source. The administration subsystem can store the operating history data of the physical asset into an operating history data. The administration subsystem can generate a reportable for the digital twin instantiation based on the model implementation instructions. The administration subsystem can transmit the reportable to the asset owner terminal. The operation subsystem can receive a current life request from the administration subsystem. The operation subsystem can determine a current life of the digital twin instantiation using the operating history data and the model implementation instructions.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is a schematic view of a system for providing digital twin services for a physical asset from multiple digital twin providers, according to certain embodiments, where the system includes provider terminals, an asset owner terminal, a physical asset, a server, and a network;

FIG. 2 is a schematic view of the system for providing digital twin services for the physical asset from multiple digital twin providers, according to certain embodiments, further including a third-party server;

FIG. 3 is a schematic view of the server, according to certain embodiments, including an administration subsystem and an operation subsystem;

FIG. 4 is schematic view of examples of the physical asset shown in FIGS. 1-2, according to certain embodiments, illustrating the different methods of providing a digital twin instantiation of the physical asset and a digital twin instantiation system for when the physical asset includes a physical asset system;

FIG. 5 is a schematic view of the system for providing digital twin services for the physical asset from multiple digital twin providers, according to certain embodiments, including an operating platform having a provider module, an asset owner module, and a graphical user interface (GUI);

FIG. 6 is a non-limiting example of an asset dashboard screen, according to certain embodiments;

FIG. 7 is a non-limiting example of an asset log screen, according to certain embodiments;

FIG. 8 is a non-limiting example of a residual life screen, according to certain embodiments;

FIG. 9 is a flowchart showing a method for providing digital twin services for the physical asset from multiple digital twin providers, according to certain embodiments; and

FIGS. 10-11 provide a flowchart showing another method for providing digital twin services for the physical asset from multiple digital twin providers, according to certain embodiments, including determining the residual life prediction.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed.

The terms “a” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. The term “about” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X can have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

All documents, including patents, patent applications, and scientific literature cited in this detailed description are incorporated herein by reference, unless otherwise expressly indicated. Where any conflict or ambiguity can exist between a document incorporated by reference and this detailed description, the present detailed description controls.

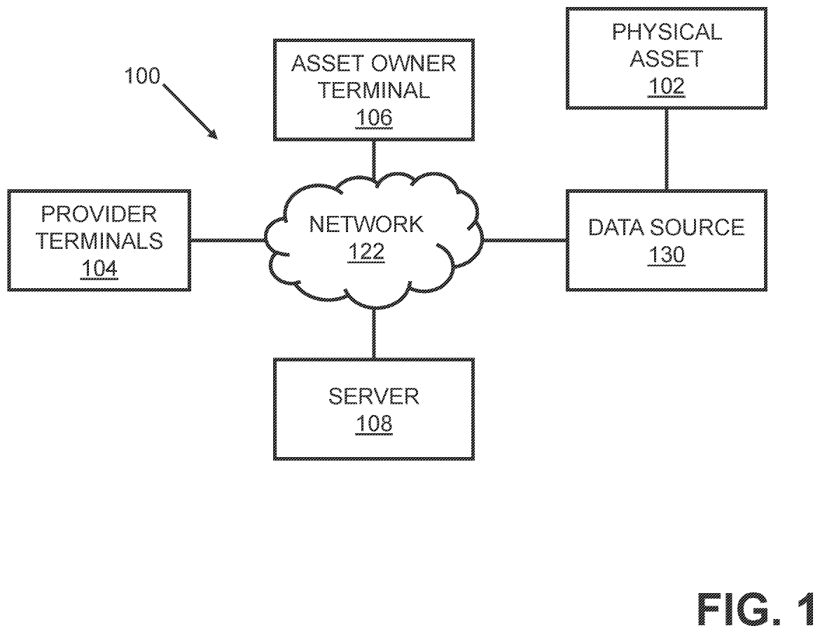

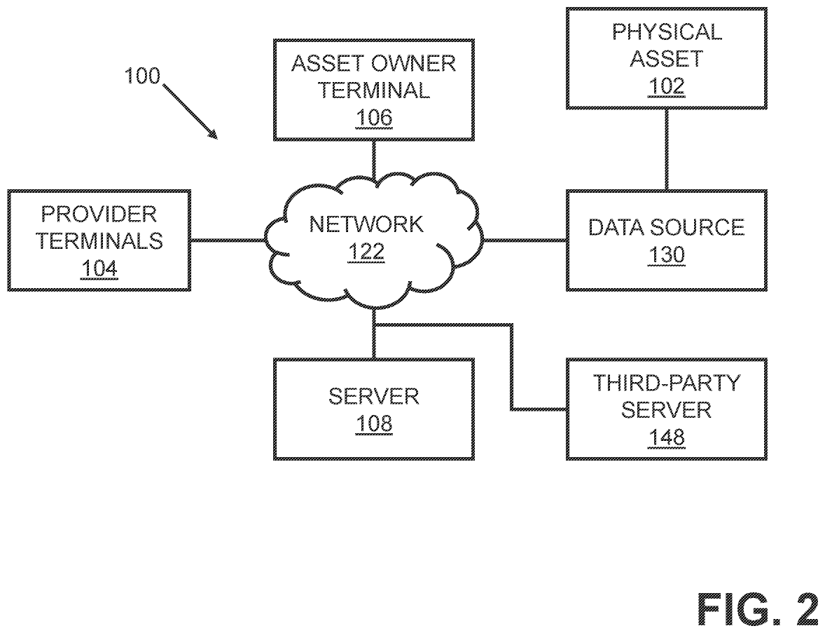

With reference to FIGS. 1-2, an embodiment of a system 100 for providing digital twin services for a physical asset 102 from multiple digital twin providers is shown. The system 100 can be configured to be used as a general-purpose structural analysis tool for various digital twin services for basic applications, semi-complex applications, and complex applications, as will be discussed in further detail herein. The system 100 can include a plurality of provider terminals 104, an asset owner terminal 106, and a server 108 with an administration subsystem 110 and an operation subsystem 112. It should be appreciated that a skilled artisan may employ other components for the system 100, within the scope of this disclosure.

Now referring to FIGS. 1-2 and 5, each of the provider terminals 104 can be configured to permit a provider to upload an asset model with model implementation instructions to the administration subsystem 110 into a model database 113. The asset model can be a digital representation or “twin” of a stock physical asset. The asset model can include multiple variables and values placed in a database format. A non-limiting example of the asset model can include a digital representation of a stock tire for a vehicle. Desirably, the asset model can be utilized by an asset owner to create a digital twin for the physical asset 102. The system 100 can allow each of the provider terminals 104 to upload asset models with the model implementation instructions to allow for a wide range of digital twins for different products.

The model implementations can be a series of instructions, algorithms, and/or formulas that permit the system 100 to process and perform the digital twin services, as will be discussed in further detail below. The model implementation instructions can include one or more of current life calculations, geometry, material properties, boundary condition definitions, initial conditions, as well as other physical, material, and environmental properties. For example, the model implementations can include the following current life calculation formula: (Current Life)=(Original Residual Life)−(Elapsed Time since the physical asset 102 has been used). In certain examples, the model implementation instructions can include a fatigue solver algorithm. For example, the fatigue solver algorithm can include the embodiments disclosed in U.S. Pub. No. 2019/0102494 to Mars, the entire disclosure of which is incorporated herein by reference. It should be appreciated that a person skilled in the art can employ different instructions, values, definitions, and algorithms for the model implementation instructions to meet the requirements for a given digital twin.

The model database 113 can be located on one of the provider terminals 104, the asset owner terminal 106, and/or the server 108. The model database 113 can be a suitable format that permits the asset models and the model implementation instructions to be stored and organized. In addition, the model database 113 can be configured to be displayed to the asset owner terminal 106 to allow the asset owner to select a suitable asset model. It should be appreciated that a skilled artisan can employ other methods and file structures to store and display the asset models, within the scope of this disclosure.

In certain examples, the asset model can be uploaded in a proprietary format to ensure compatibility with the server 108. In other instances, the server 108 can be compatible with asset models created in different formats, such as asset models created using ABAQUS™. It should be appreciated that one skilled in the art can employ different formats for the asset model, within the scope of this disclosure. Each of the provider terminals 104 can also be configured to allow the provider to manage the uploaded asset model with the model implementation instructions. Advantageously, this can permit the provider to update the asset model and the model implementation instructions to more accurately produce digital twin services.

With continued reference to FIGS. 1-2 and 5, the asset owner terminal 106 can be configured to permit an asset owner to view the model database 113 and request a digital twin instantiation 114 of a selected asset model from the model database 113. Desirably, the model database 113 can include a variety of different asset models that can be compatible with the physical asset 102. The asset owner terminal 106 can be further configured to permit the asset owner to manage the digital twin instantiation 114. This can include requesting a reportable for the digital twin instantiation 114. A non-limiting example of the reportable can include a status report. The reportable can be based on the model implementation instructions. It should be appreciated that other information can be provided in the reportable, within the scope of this disclosure.

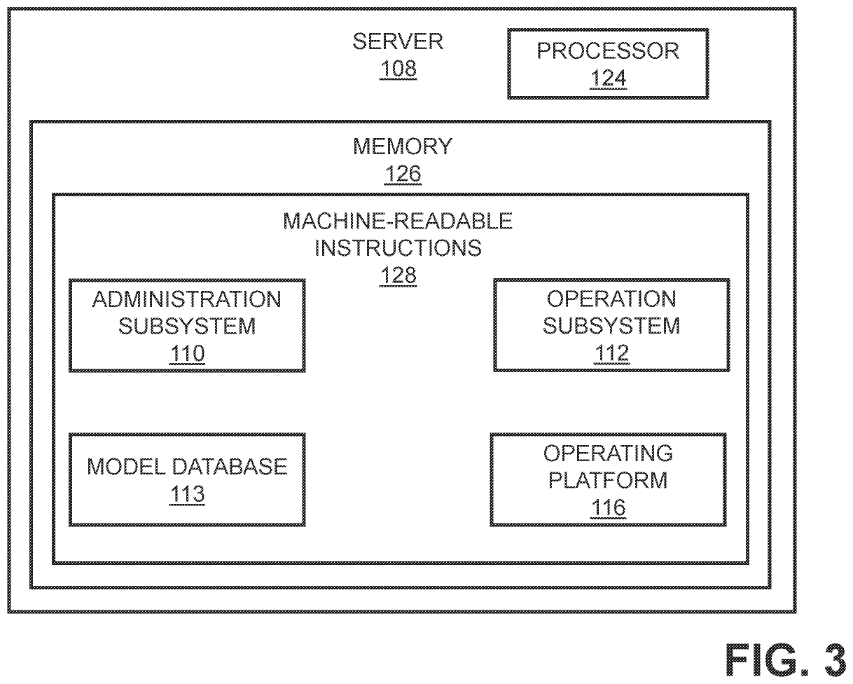

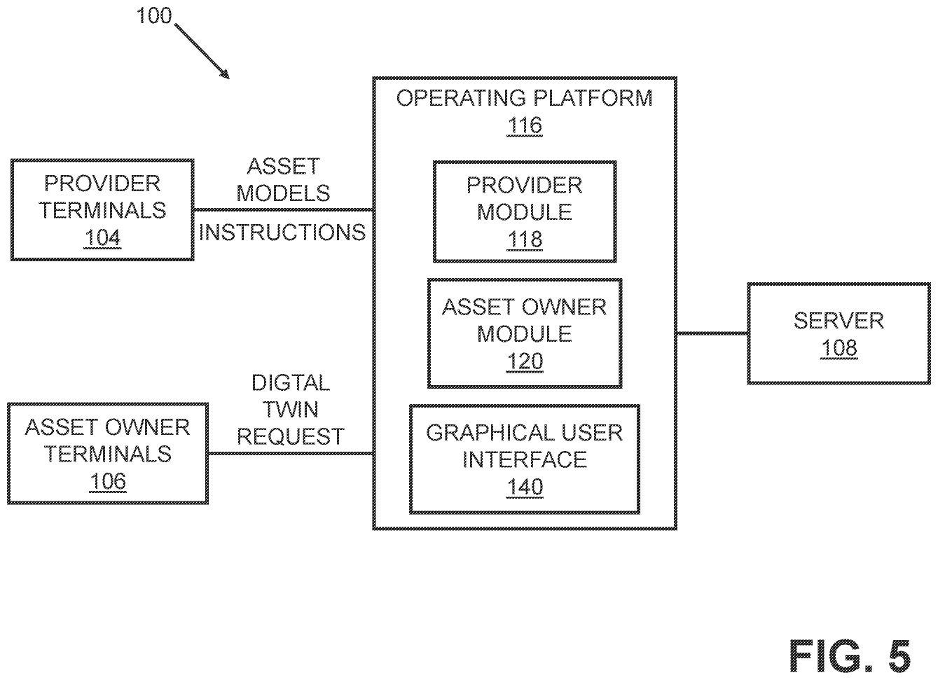

Each of the provider terminals 104 and the asset owner terminal 106 can include a computer, such as a laptop, desktop, a mobile phone, a tablet, and/or any other suitable electronic device for data entry. Other devices may also be employed for the provider terminals 104 and the asset owner terminal 106, within the scope of this disclosure. With reference to FIGS. 3 and 5, in certain examples, the system 100 can include an operating platform 116. The operating platform 116 can include a provider module 118 and an asset owner module 120. The provider module 118 can be configured to permit one of the provider terminals 104 to upload and manage the asset model with the model implementation instructions. The asset owner model can be configured to permit the asset owner terminal 106 to view the model database 113, request the digital twin instantiation 114 of the selected asset model, and manage the digital twin instantiation 114. The operating platform 116 can be located on one of the provider terminals 104, the asset owner terminal 106, and/or the server 108. For example, as shown in FIG. 3, the operating platform 116 can be located on the server 108. In certain examples, the operating platform 116 can include a software platform, including machine readable instructions fixed in a tangible medium. The software platform can be accessed by the asset owner terminal 106 and/or one of the provider terminals 104 via a desktop application, a mobile application, and/or a web application. Other methods of accessing the software platform can also be provided, within the scope of this disclosure. It should be appreciated that the provider module 118 and the asset owner module 120 can be combined into a single module and/or split into more modules. In addition, it should be appreciated that a skilled artisan can select other modules to be included in the operating platform 116, as desired.

As shown in FIGS. 1-2, the server 108 can be in communication with the plurality of provider terminals 104 and the asset owner terminal 106. This can be accomplished via a network 122, which can include wireless and/or wired connections. It should be appreciated that the network 122 of the system 100 can include various wireless and wired communication networks, including a radio access network, such as LTE or 5G, a local area network (LAN), a wide area network (WAN) such as the Internet, or wireless LAN (WLAN), as non-limiting examples. It will be appreciated that such network examples are not intended to be limiting, and that the scope of this disclosure includes implementations in which one or more computing platforms of the system 100 can be operatively linked via some other communication coupling, including combinations of wireless and wired communication networks. One or more components and subcomponents of the system 100 can be configured to communicate with the networked environment via wireless or wired connections. In certain embodiments, one or more computing platforms can be configured to communicate directly with each other via wireless or wired connections. Examples of various computing platforms and networked devices include, but are not limited to, smartphones, wearable devices, tablets, laptop computers, desktop computers, Internet of Things (IoT) devices, or other mobile or stationary devices such as standalone servers, networked servers, or an array of servers.

Now referencing FIG. 3, the server 108 can include a processor 124, a memory 126, the administration subsystem 110, and the operation subsystem 112. The memory 126 can have a tangible, non-transitory computer readable medium with processor-executable instructions 128 stored thereon. The administration subsystem 110 can be configured to perform several different functions. The administration subsystem 110 can be configured to receive and store a plurality of the asset models with the model implementation instructions, from at least one of the provider terminals 104, into the model database 113. The system 100 can support multiple digital twin providers to upload different asset models. Desirably, this can provide a wide selection of digital twins for the asset owner. The administration subsystem 110 can also be configured to receive a digital twin request, from the asset owner terminal 106, for creating the digital twin instantiation 114 of the selected asset model from the model database 113. Upon receiving the digital twin request, the administration subsystem 110 can be configured to create the digital twin instantiation 114, which is a “clone” or instantiation of the selected asset model. Advantageously, the digital twin instantiation 114 can be utilized with different digital twin services.

The administration subsystem 110 can be further configured to receive operating history data of the physical asset 102 from a data source 130. The operating history data can include information representing the history of a loads of the physical asset 102, a displacement of the physical asset 102, a temperature of the physical asset 102, an acceleration of the physical asset 102, a stress of the physical asset 102, a strain of the physical asset 102, exposure of the physical asset 102 to environmental factors, and combinations thereof. As will be discussed in further detail below, the operating history data can be used to keep the digital twin instantiation 114 up to date to more accurately reflect the physical asset 102. In addition, the operating history data can be used for predictions relating to a life span on the physical asset 102. The operating history data can be stored on one of the provider terminals 104, the asset owner terminal 106, and/or the server 108. It should be appreciated that a skilled artisan can select other information to be included in the operating history data, within the scope of this disclosure.

The data source 130 can include the asset owner manually inputting the operating history data into the asset owner terminal 106. In certain examples, the data source 130 can include one or more sensors 130, which can measure and record the operating history data. The sensor 130 can be in communication with the physical asset 102 so that it can monitor and/or measure the operating history data. In certain embodiments, the sensor 130 can be configured to monitor and/or measure the load of the physical asset 102, the displacement of the physical asset 102, the temperature of the physical asset 102, the acceleration of the physical asset 102, the stress of the physical asset 102, the strain of the physical asset 102, exposure to environmental factors, and combinations thereof. The administration subsystem 110 can be configured to automatically receive the operating history data from the sensor 130 at a predetermined interval. Non-limiting examples of the predetermined interval can include every hour, day, week, monthly, etc. In certain examples, the administration subsystem 110 can continuously and automatically receive the operating history data from the sensor 130. It should be appreciated that one skilled in the art can select different data to be monitored and/or measured by the sensor 130, as desired.

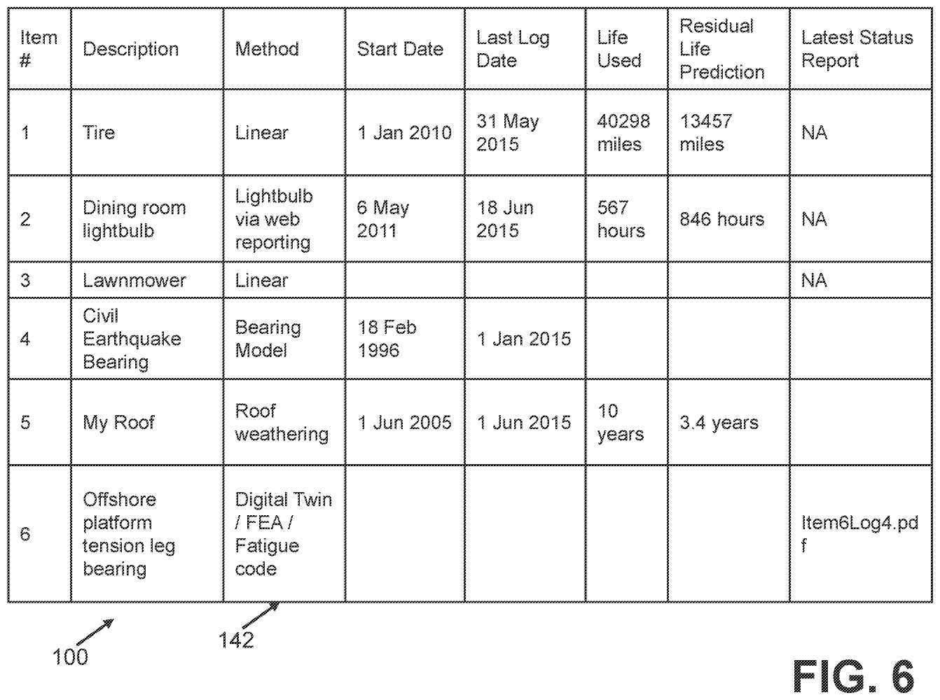

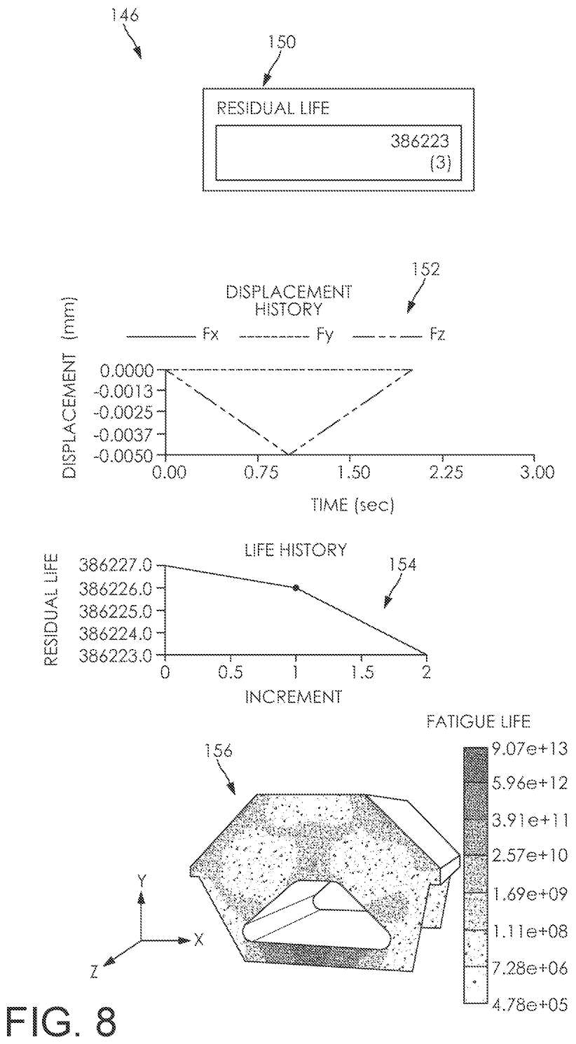

The administration subsystem 110 can also be configured to generate the reportable for the digital twin instantiation 114 and transmit the reportable to the asset owner terminal 106. With reference to FIGS. 6-8, the reportable can include relevant information to assist in determining when the asset owner needs to perform maintenance on the physical asset 102 and/or when the physical asset 102 will fail. Non-limiting examples of the reportable can include one or more predictions, elapsed operation time, status reports, log histories, visualizations, and/or notifications. Other types of information can also be included in the reportable, as desired.

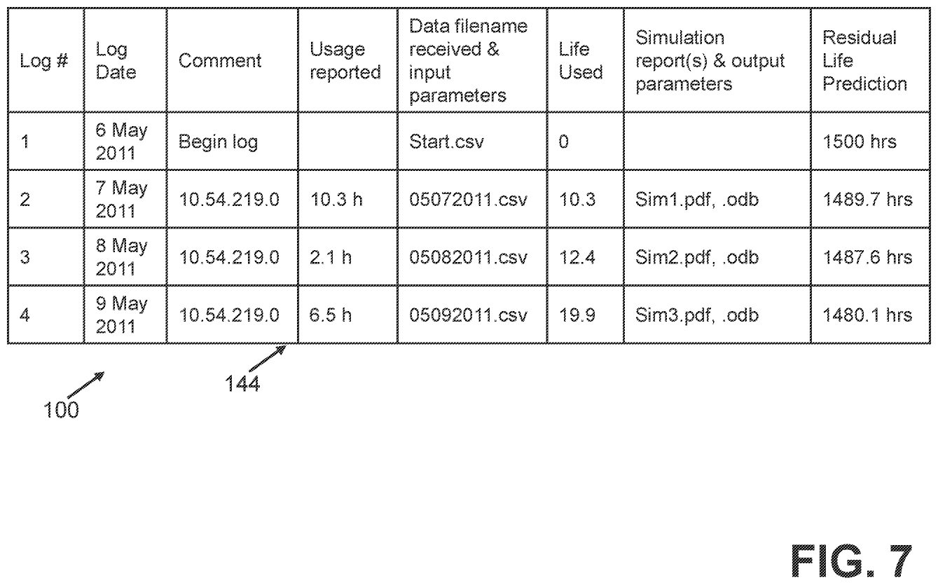

As shown in FIG. 7, the log histories can have information relating to when the operating history data was uploaded, a log entry number, a log date, a comment field, a usage report, a list of data filenames received with input parameters, the life-used-to-date, simulation reports with output parameters, and/or predictions. It should be appreciated that a person skilled in the art may include other information for the log histories, as desired.

The notifications may be selectively enabled by the asset owner to allow the administration subsystem 110 to send notifications to the asset owner terminal 106. The notifications may include at least one of a fitness event warning, an end-of-life warning, a remaining life prediction, and/or other relevant events. It should be appreciated that the notifications may include warnings of other events and other relevant information, within the scope of this disclosure.

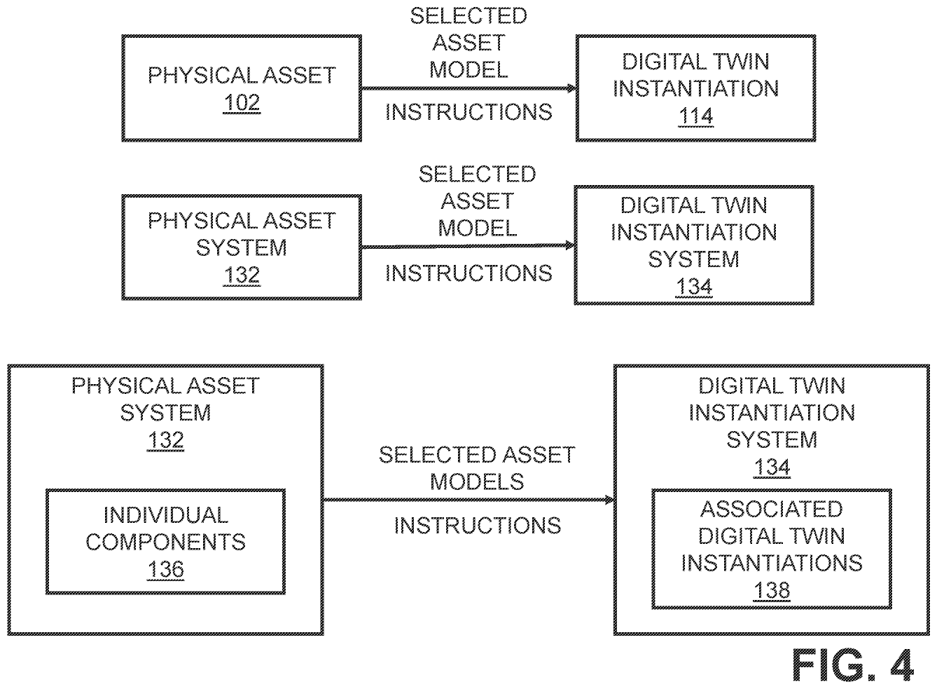

Now referencing FIG. 4, the physical asset 102 can be a physical asset system 132, the asset model can be a digital representation or “twin” of a stock physical system, and the digital twin instantiation 114 can be digital twin instantiation system 134. The digital twin instantiation system 134 can be a digital representation or “twin” of an entirety of the physical asset system 132. Desirably, this can allow the asset owner to determine when to perform maintenance on the physical asset system 132.

In certain examples, the physical asset system 132 can also include a plurality of individual components 136. Each of the individual components 136 can have an associated digital twin instantiation 138. The associated digital twin instantiation 138 of each of the individual components 136 can be generated from selected asset models and the model implementation instructions. The associated digital twin instantiation 138 of each of the individual components 136 in combination can represent the digital twin instantiation system 134. In some instances, the associated digital twin instantiation 138 of one of the individual components 136 can be different from the associated digital twin instantiation 138 of another one of the of the individual components 136. Advantageously, this can permit having digital twins of individual components 136 that are not the same type of component. As a non-limiting example, the physical asset system 132 can be a car, while one of the individual components 136 can be a tire and another one of the individual components 136 can be a timing belt. In addition, the associated digital twin instantiation 138 of one of the individual components 136 can be provided by a provider different from the associated digital twin instantiation 138 of another one of the individual components 136; e.g., different tire manufacturers. Desirably, this can facilitate competition among the providers and allow the asset owner to choose the asset model that best meets a given application.

Each of the associated digital twin instantiations 138 can have an individual component specific reportable. The individual component specific reportable can include relevant information to assist in determining when the asset owner needs to perform maintenance on one of the individual components 136 of the physical asset system 132 and/or when one of the individual components 136 of the physical asset system 132 will fail. Advantageously, this can allow the asset owner to determine when to perform maintenance on one of the individual components 136 of the physical asset system 132.

The operation subsystem 112 can be configured to perform several different functions.

For instance, the operation subsystem 112 can be configured to receive a current life request from the administration subsystem 110. Upon receiving the current life request, the operation subsystem 112 can be configured to determine a current life of the digital twin instantiation 114 using the operating history data and the model implementation instructions. The current life updates the digital twin instantiation 114 to reflect a condition of the physical asset 102 based on the operating history data and the model implementation instructions. In other words, the current life can reflect changes the physical asset 102 has experienced during use compared to a stock version of the physical asset 102. The current life can include a remaining life of the physical asset, in terms of time, mileage, and/or etc. Desirably, this can allow the digital twin instantiation 114 to be an accurate digital representation of the physical asset 102 to reflect the changes that the physical asset 102 has undergone during use. In certain examples, the current life can be calculated, as described in U.S. Pub. No. 2019/0102494 to Mars. It should be appreciated that determining the current life can vary based on a type of the physical asset 102 and the model implementation instructions.

As a non-limiting example, if the physical asset 102 is a roof that has been used for ten years, the asset owner could select the preselected asset model that is a stock version of the roof with model implementation instructions, such as (Current Life)=(Original Residual Life)−(Elapsed Time since the physical asset 102 has been used), whereby the original residual life is twenty years. The administration subsystem 110 could receive the elapsed time since the roof has been installed, as the operating history data. Then, the operation subsystem 112 could calculate the current life as ten years.

The operation subsystem 112 can be also configured to receive a residual life prediction request from the administration subsystem 110. Upon receiving the residual life prediction request, the operation subsystem 112 can determine a residual life prediction by using the model implementation instructions, the current life, and/or a hypothetical operating history data. The residual life prediction can be indicative of a residual life before reaching a predetermined state associated with the physical asset 102 in operation. The predetermined state can be the condition of the physical asset 102 that the assent owner and/or provide determines is a desirable time for maintenance and/or replacement. As a non-limiting example, where the physical asset 102 is a tire, the predetermined state can include a state where the tire pressure becomes too low. In another non-limiting example, where the physical asset 102 is a roof, the predetermined state can include a state where the roof is close to facilitating a leak. Desirably, the residual life prediction can be used by the asset owner to determine if the physical asset 102 is about to fail and needs to be repair/replaced. In some instances, the hypothetical operating history data can include a number of cycles of a hypothetical ideal load of the physical asset 102 or operational averages based upon a particular operational history of the physical asset 102. This can be used by the asset owner to determine when the physical asset 102 will fail based on the hypothetical ideal load, according to a given application of the physical asset 102. In other instances, the hypothetical operating history data can include a number of cycles of a total of the operating history data. This can be useful to determine when the physical asset 102 will fail if the physical asset 102 continues to experience identical/similar experiences that the physical asset 102 has already experienced. It should be appreciated that one skilled in the art can employ different data and methodologies for the hypothetical ideal load, within the scope of this disclosure. In certain examples, the residual life prediction can be calculated, as described in U.S. Pub. No. 2019/0102494 to Mars. It should be appreciated that determining the residual life prediction can vary based on a type of the physical asset 102 and the model implementation instructions.

As a non-limiting example, if the physical asset 102 is a tire that has been used for ten years, the asset owner could select the preselected asset model that is a stock version of the tire with model implementation instructions. The administration subsystem 110 could receive the operating history data, such as the number of miles driven with the tire, the average temperature that the tire is exposed to, the average tire pressure, and/or etc. The operation subsystem 112, using the model implementation instructions and the operating history data, could determine that tire has 40,298 miles remaining based on its original life expectancy. Then, the operation subsystem 112 could determine that the tire has 13,457 miles remaining as the residual life prediction, based on a number of cycles of a total of the operating history data.

The administration subsystem 110 can be configured to send the current life request and the residual life prediction request to the operation subsystem 112 at a set request predetermined interval. Advantageously, this can allow the digital twin instantiation 114 to be automatically updated with the current life and/or the residual life prediction to remain an up-to-date digital representation of the physical asset 102. Non-limiting examples of the request predetermined interval can include hourly, daily, weekly, and/or monthly. In addition, the reportable transmitted by the administration subsystem 110 can include the current life and the residual life prediction.

It should be appreciated that the administration subsystem 110 and the operation subsystem 112 can be combined into a single subsystem and/or split into additional subsystems, within the scope of this disclosure. In addition, it should be appreciated that a skilled artisan may employ additional servers for the server 108, as desired.

With reference to FIG. 5, the operating platform 116 can be interacted with via a graphical user interface (GUI) 140. The GUI 140 can have a plurality of screens, including an asset dashboard screen 142, an asset log screen 144, and a residual life screen 146. The asset dashboard screen 142 can include a listing of created digital twin instantiations 114 along with other relevant information. The asset log screen 144 can include the log histories, as described above. The residual life screen 146 can include relevant information and graphs associated with the residual life prediction. For example, the residual life screen 146 can include a residual life prediction graphical representation 150, a displacement history graph 152, a life history graph 154, and a fatigue life graphical representation 156 of the physical asset 102. The residual life prediction graphical representation 150 can display a number of standard load cycles remaining for the physical asset 102. The displacement history graph 152 can visualize displacement of the physical asset 102 over a period of time. The life history graph 154 can illustrate the changes in the residual life prediction as the current life is updated in standard load cycle increments. The fatigue life graphical representation 156 can visualize a number of standard load cycles remaining for different portions of the physical asset 102.

In certain embodiments, the operating platform 116 can be accessed from and/or reside on one or more of the provider terminals 104, the asset owner terminal 106, and/or the server 108. In this way, aspects of the operating platform 116 can be displayed, confirmed, selected, annotated, updated, and/or changed using the GUI 140. For example, the asset owner can use the asset owner terminal 106 to update the data source 130 of the physical asset 102 through the operating platform 116. Providers or manufactures of the physical asset 102 can also use the provider terminals 104 to update the data source 130 of the physical asset 102 as well as the asset models in the model database 113 through the operating platform 116. Likewise, aspects of the sensor 130 can be viewed using the GUI 140, including updates of the operating history data of the physical asset 102 by the sensor 130 provided through the operating platform 116.

As shown in FIG. 2, the operation subsystem 112 can include a third-party server 148 in communication with the server 108. The third-party server 148 can be identical or similar to the operation subsystem 112. In certain examples, the third-party server 148 can be used for specialized asset models. The third-party server 148 can be useful when dealing with the specialized asset models that can be more computation intensive and/or of a proprietary design. Desirably, this can allow the system to offload computation intensive operations on the third-party server 148. In addition, the third-party server 148 can allow for the specialized asset models having proprietary designs. It should be appreciated that one skilled in the art can utilize the third-party server 148 in different ways, within the scope of this disclosure.

The operation subsystem 112 can also include an interpolation engine. The interpolation engine can be configured to interpolate partially generated parameters when calculating the current life and the residual life prediction. Advantageously, this can reduce the computation time on the current life and the residual life prediction calculations, which can reduce the load on the operation subsystem 112. In certain examples, the interpolation engine can include embodiments as described in U.S. Pat. No. 9,645,041 to Mars, the entire disclosure of which is hereby incorporated by reference. However, it should be appreciated that a skilled artisan can select different technologies and methods for the interpolation engine, as desired.

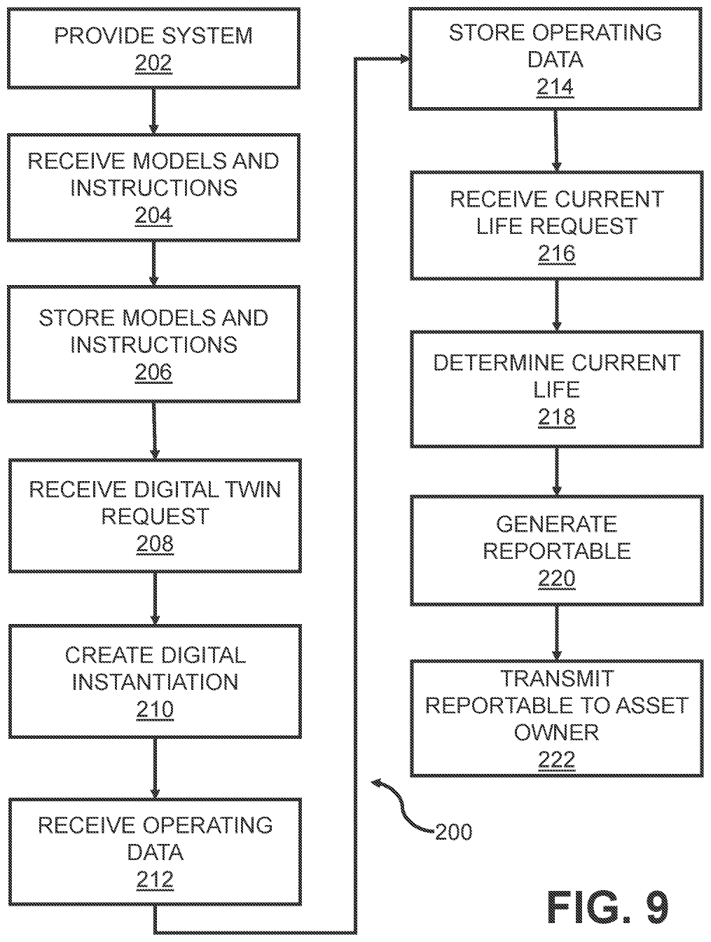

Now referring to FIG. 9, a method 200 for providing the digital twin services for the physical asset 102 from the multiple digital twin providers is shown. The method 200 can have a step 202 of providing an embodiment of the system 100. In a step 204, the administration subsystem 110 can receive the plurality of the asset models with the model implementation instructions from at least one of the provider terminals 104. The administration subsystem 110 can store the plurality of the asset models with the model implementation instructions into the model database 113, in a step 206. In a step 208, the administration subsystem 110 can receive the digital twin request from the asset owner terminal 106, for creating the digital twin instantiation 114 of the selected asset model from the model database 113. The administration subsystem 110 can create the digital instantiation for the physical asset 102, in a step 210. In a step 212, administration subsystem 110 can receive the operating history data of the physical data from the data source 130. The administration subsystem 110 can store the operating history data of the physical asset 102, in a step 214. In a step 216, the operation subsystem 112 can receive the current life request from the administration subsystem 110. The operation subsystem 112 can determine the current life of the digital instantiation using the operating history data and the model implementation instructions, in a step 218. In a step 220, the administration subsystem 110 can generate the reportable for the digital twin instantiation 114. The administration subsystem 110 can transmit the reportable to the asset owner terminal 106, in a step 222.

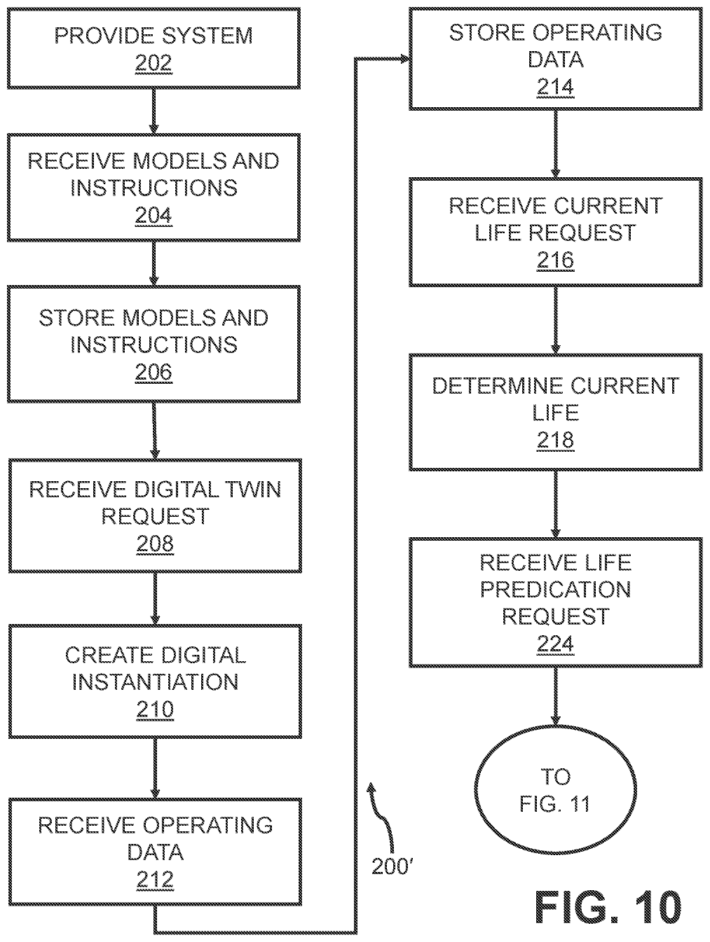

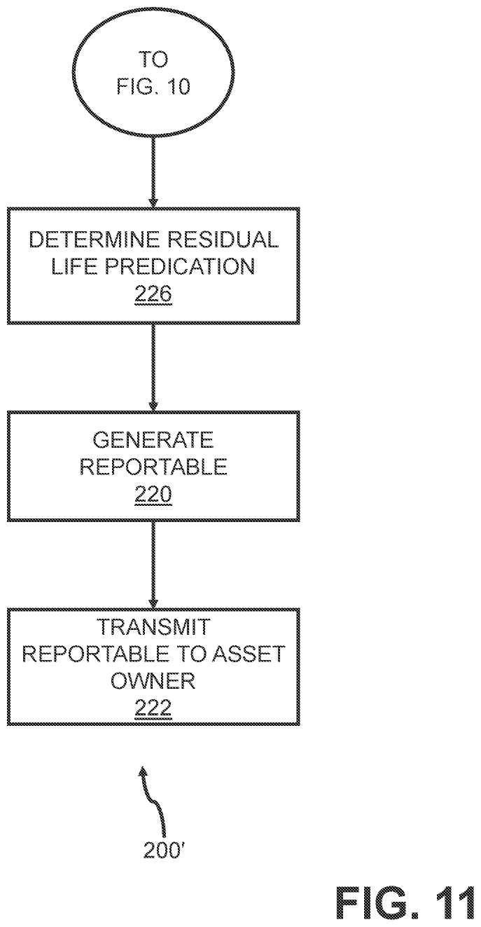

With reference to FIGS. 10-11, a method 200′ can include the operation subsystem 112 can receive the residual life prediction request from the administration subsystem 110, in a step 224. In a step 226, the operation subsystem 112 can determine the residual life prediction by using the model implementation instructions, the current life, the hypothetical operating history data. The residual life prediction can be indicative of the residual life before reaching the predetermined state associated with the physical asset 102 in operation. The reportable can be based on the model implementation instructions, the current life, and/or the residual life prediction.

Advantageously, embodiments of the system 100 and methods 200, 200′ provided by the present technology can provide digital twin services, such as creating and managing the digital twin instantiation 114. Additional digital twin services can also include calculating the current life and the residual life prediction. In addition, the system 100 can facilitate support for a broad range of physical assets 102 by allowing the plurality of provider terminals 104 to upload the asset models and the model implementation instructions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A system for providing digital twin services for a physical asset from multiple digital twin providers, comprising:
a plurality of provider terminals;
an asset owner terminal; and
a server in communication with the plurality of provider terminals and the asset owner terminal, the server including:
a processor;
a memory including a tangible, non-transitory computer readable medium with processor-executable instructions stored thereon;
an administration subsystem configured to:
receive a plurality of asset models with model implementation instructions from at least one of the provider terminals;
store the plurality of asset models with the model implementation instructions into a model database;
receive a digital twin request, from the asset owner terminal, for creating a digital twin instantiation of a selected asset model from the model database;
create the digital twin instantiation for the physical asset;
receive operating history data of the physical asset from a data source;
store the operating history data of the physical asset;
generate a reportable for the digital twin instantiation; and
transmit the reportable to the asset owner terminal;
an operation subsystem configured to:
receive a current life request from the administration subsystem;
determine a current life of the digital twin instantiation using the operating history data and the model implementation instructions;
wherein the reportable includes the current life of the digital twin instantiation.

2. The system of claim 1, wherein the data source includes data manually entered and transmitted from the asset owner terminal.

3. The system of claim 1, wherein the data source includes data from a sensor in communication with the physical asset.

4. The system of claim 3, wherein the administration subsystem is configured to receive the data continuously and automatically from the sensor.

5. The system of claim 3, wherein the sensor is configured to monitor a member selected from a group consisting of a load of the physical asset, a displacement of the physical asset, a temperature of the physical asset, an acceleration of the physical asset, a stress of the physical asset, a strain of the physical asset, an exposure to an environmental factor, and combinations thereof.

6. The system of claim 1, wherein the operation subsystem is further configured to: receive a residual life prediction request from the administration subsystem; determine a residual life prediction by using the model implementation instructions, the current life, and a hypothetical operating history data; and wherein the residual life prediction is indicative of a residual life before reaching a predetermined state associated with the physical asset in operation.

7. The system of claim 6, wherein the administration subsystem is configured to send at least one of the current life request and the residual life prediction request to the operation subsystem at a set predetermined interval.

8. The system of claim 6, wherein the hypothetical operating history data includes a number of cycles of a hypothetical ideal load case.

9. The system of claim 6, wherein the hypothetical operating history data includes a number of cycles based on a total of the operating history data.

10. The system of claim 1, wherein the operation subsystem includes a third-party server.

11. The system of claim 1, wherein the operation subsystem further includes an interpolation engine configured to accelerate computation time.

12. The system of claim 1, further comprising an operating platform including a provider module and an asset owner module, the provider module configured to permit one of the provider terminals to upload and manage the plurality of asset models and model implementation instructions, and the asset owner module configured to permit the asset owner terminal to request a creation of the digital twin instantiation of the selected asset model from the model database.

13. The system of claim 1, wherein the physical asset is a physical asset system.

14. The system of claim 13, wherein the physical asset system includes a plurality of individual components, each of the individual components having an associated digital twin instantiation.

15. The system of claim 14, wherein the associated digital twin instantiation of one of the individual components is different from the associated digital twin instantiation of another one of the individual components.

16. The system of claim 15, wherein the associated digital twin instantiation of one of the individual components is provided by a provider different from the associated digital twin instantiation of the another one of the individual components.

17. A system for providing digital twin services for a physical asset from multiple digital twin providers, comprising:
a plurality of provider terminals;
an asset owner terminal; and
a server in communication with the plurality of provider terminals and the asset owner terminal, the server including:
a processor;
a memory including a tangible, non-transitory computer readable medium with processor-executable instructions stored thereon; and
an administration subsystem configured to:
receive a plurality of asset models with model implementation instructions from at least one of the provider terminals;
store the plurality of asset models with the model implementation instructions into a model database;
receive a digital twin request, from the asset owner terminal, for creating a digital twin instantiation of a selected asset model from the model database;
create the digital twin instantiation for the physical asset;
receive operating history data of the physical asset from a data source;
store the operating history data of the physical asset;
generate a reportable for the digital twin instantiation; and
transmit the reportable to the asset owner terminal;
an operation subsystem configured to:
receive a current life request from the administration subsystem;
determine a current life of the digital twin instantiation using the operating history data and the model implementation instructions;
receive a residual life prediction request from the administration subsystem; and
determine a residual life prediction by using the model implementation instructions, the current life, and a hypothetical operating history data, the residual life prediction being indicative of a residual life before reaching a predetermined state associated with the physical asset in operation,
wherein the reportable includes at least one of the current life and the residual life prediction.

18. A method for providing digital twin services for a physical asset from multiple digital twin providers, comprising:
providing a system for providing the digital twin services for the physical asset from the multiple digital twin providers, the system having a plurality of provider terminals, an asset owner terminal, and a server in communication with the plurality of provider terminals and the asset owner terminal, the server including:
a processor, a memory including a tangible, non-transitory computer readable medium with processor-executable instructions stored thereon, an administration subsystem, and an operation subsystem;
receiving, by the administration subsystem, a plurality of asset models with model implementation instructions from at least one of the provider terminals;
storing, by the administration subsystem, the plurality of asset models with the model implementation instructions into a model database;
receiving, by the administration subsystem, a digital twin request from the asset owner terminal, for creating a digital twin instantiation of a selected asset model from the model database;
creating, by the administration subsystem, the digital twin instantiation for the physical asset;
receiving, by the administration subsystem, operating history data of the physical asset from a data source;
storing, by the administration subsystem, the operating history data of the physical asset;
receiving, by the operation subsystem, a current life request from the administration subsystem;
determining, by the operation subsystem, a current life of the digital twin instantiation using the operating history data and the model implementation instructions.
generating, by the administration subsystem, reportable for the digital twin instantiation; and
transmitting, by the administration subsystem, the reportable to the asset owner terminal.

19. The method of claim 18, further including: receiving, by the operation subsystem, a residual life prediction request from the administration subsystem; determining, by the operation subsystem, a residual life prediction by using the model implementation instructions, the current life, and a hypothetical operating history data; and the residual life prediction being indicative of a residual life before reaching a predetermined state associated with the physical asset in operation.

20. The method of claim 19, wherein the administration subsystem sends at least one of the current life request and the residual life prediction request to the operation subsystem at a set predetermined interval.
